(19) United States
(12) Patent Application Publication
(10) Pub. No.: US 2022/0409465 A1
(43) Pub. Date: Dec. 29, 2022

(54) SPINAL THERAPY APPARATUS

(71) Applicant: Pacla Medical Limited, Edinburgh (GB)

(72) Inventors: Chongsu LEE, Edinburgh (GB); Marco MIGLIONICO, Edinburgh (GB); Matthew LOVE, Glasgow (GB)

(73) Assignee: Pacla Medical Limited, Edinburgh (GB)

(21) Appl. No.: 17/606,461

(22) PCT Filed: Apr. 23, 2020
(86) PCT No.: PCT/GB2020/051007

§ 371 Date: Oct. 26, 2021

(30) Foreign Application Priority Data
Apr. 26, 2019 (GB) 1905889.0

(51) Int. Cl. A61H 1/00

(52) U.S. Cl. CPC A61H 1/008; A61H 2201/0142; A61H 2201/018; A61H 2201/0196; A61H 2201/1207; A61H 2201/1623; A61H 2201/1647; A61H 2201/5061; A61H 2203/0456

(57) ABSTRACT

A spinal therapy apparatus includes one or more manipulating assemblies. In some examples a first manipulating member is arranged to engage a spine at a first vertebral area between a spinous process and a transverse process on a first side of a spine and a second manipulating member is arranged to engage the spine at a second vertebral area between a spinous process and a transverse process on the first side of the spine. The first and second manipulating members are coupled together at their proximal ends to permit the first and second manipulating members to be driven simultaneously and the coupling permits motion of the first and second manipulating members relative to one another in an axial direction. In other examples a drive system is adapted to drive first and second manipulating members simultaneously and independently. The disclosure also relates to a spinal therapy bed including such manipulating assemblies and methods of using and training spinal therapy devices.

The present invention belongs to the field of back therapy applied to mitigate the symptoms of back pain and stiffness.

Neck and back tension or stiffness and resulting problems may be caused by a range of different issues, such as from an accident, to day-to-day activities such as sleeping, standing and sitting positions throughout the day. Tension may become chronic and also may be associated with Multiple Sclerosis, MS, Chronic Fatigue Syndrome, any form of physical or emotional stress, trapped nerve, etc. MS in particular may cause back problems, as it is an inflammatory disease in which the insulating covers of nerve cells in the brain and spinal cord are damaged. Pain caused by any of the above scenarios and conditions can be treated by relieving the symptoms of stiffness and tension in the back.

Each of the vertebrae that make up the spine may suffer different stresses or tensions individually and independently of the other vertebrae, such that tension is not uniformly distributed about the length of the spine. The spine has varying degrees of curvature that may exacerbate stiffness or tension in localised vertebral areas. Other causes of distributed spinal pain may include locations of particular injuries or other external factors.

Manipulation or massaging of the spine may provide pain relief and release of built up tension. As a result of non-uniform distribution of pain along the length of the spine, personalised treatments to the localised vertebral areas can provide greater relief than treatments that address the spine as a whole.

Spinal therapy beds and devices designed to address the different problematic areas of the spine along the entire length of the spine can be both physically cumbersome and energy intensive when small or localised vertebral areas are targeted. There is thus a desire for an architecture that provides individual, targeted manipulation of the vertebrae that can be personalised to suit the needs of any individual suffering back pain of any kind.

Our earlier application WO 2017/168140 A1 discloses apparatus which addresses a number of pre-existing shortcomings in prior art devices. Further research has identified a number of closely linked, alternative or improved solutions to one or more of the problems set out above. Specifically, the solutions set out below may provide treatment of a large portion of a user's spine, while allowing highly individualised or more effective or efficient treatment to specific spinal regions without requiring an unduly cumbersome apparatus.

Aspects of the invention are set out in the independent claims and preferred features are set out in the dependent claims.

According to a first aspect of the present invention there is provided a manipulating assembly for a spinal therapy device, the assembly comprising: a first manipulating member arranged to engage a spine at a first vertebral area between a spinous process and a transverse process on a first side of a spine; a second manipulating member arranged to engage the spine at a second vertebral area between a spinous process and a transverse process on the first side of the spine, wherein the second vertebral area is spaced along the spine relative to the first vertebral area; wherein each manipulating member having a portion for engaging the spine at a distal end; wherein the first and second manipulating members are coupled together at their proximal ends to permit the first and second manipulating members to be driven simultaneously; and wherein the coupling between the proximal ends of the first and second manipulating members permits motion of the first and second manipulating members relative to one another in the axial direction.

The effectiveness of spinal therapy can be limited by the personalisation of treatment to individual vertebrae or the area surrounding it. Each vertebra has a spinous process aligned with the centre of the bone, and two transverse processes that extend on either side of the spinous process. To provide therapy to reduce tension in the back or neck, force may be applied to an area between the spinous process and each of the transverse processes.

The spine comprises vertebral regions along the full length of the spine which may have differing levels of tension. Tension creates denser tissue around the spine compared to areas of relaxed, softer tissue. Manipulating members or massage fingers located at different vertebral locations along the spine may require greater or weaker applied force to release the tension, depending on the density of the tissue. By coupling two manipulating members at their distal ends such that they can be driven simultaneously, for example in the same direction and at the same time, yet move relative to one another in an axial direction, areas of differing tension can be compensated for. The manipulating members being reactive to the individual conditions of the user's spine at each manipulation location by virtue of the coupling allowing relative motion of the manipulating members, creates a personalised experience for every user, which depends directly on areas of more and less dense tissue.

Tissue density, rigidity or stiffness can be indicative measurements for determining whether tissue needs treatment (and how much, how forceful, etc.). In spinous regions of less dense tissue, a manipulating member exerting a force in the axial direction towards a user may result in the manipulating member travelling further into the tissue compared to a manipulating member exerting the same force on denser tissue. As a result, distance travelled by the manipulating member into the tissue is greater along the axial direction in areas of the spine that have less dense tissue compared to those of denser tissue when an equal force is applied. Where coupled manipulating members that are driven with an equal force encounter a difference in tissue density (by virtue of the coupling described above) this manifests as a relative motion of manipulating members along their axial direction. In this way, dense, rigid or stiff tissue which may be more sensitive to manipulation involving a large displacement (i.e. linear translation) of the manipulating member into the tissue is inherently protected from such displacements by virtue of its stiffness. In other words, the coupling between the manipulating members automatically compensates for differences in tissue stiffness, thereby ensuring that a firm and effective treatment is provided which is nonetheless tailored to the local tissue requirements.

Providing manipulating members that may be driven simultaneously by virtue of their coupling advantageously reduces the required number of motors or actuators to drive members to manipulate all the targeted areas of the spine whilst maintaining the precision to manipulate specific locations along the length of the spine at individualised and localised pressure levels. This results in reduced energy consumption of the therapy device and a smaller amount of noise generated, which may improve the experience of the user in that tissues of different stiffness receive treatment at a pressure and displacement suitable for that tissue stiffness. Clearly the nature of the coupling can be adjusted to ensure that a given amount of differential tissue stiffness (difference in tissue stiffness between the tissue in the first and second vertebral areas) allows a particular amount of relative axial motion between each manipulating member. In some cases, the coupling can be such that the amount of relative axial motion depends in a non-linear manner on the differential tissue stiffness.

Coupling a pair of manipulating members between their proximal ends to be driven simultaneously and in a same manner ensures that a range of motion in an axial direction (the linear translation or displacement) of each of the members can be personalised as a result of the force exerted on the member by areas of more or less dense tissue. An imbalance of the reaction of manipulating members interacting with tissue of differing density can be mitigated for by permitting motion of the members relative to one another, which in some cases may have a range of motion similar to the full extent of the manipulating member in the axial direction, and in other cases may be somewhat less than this. Beneficially, the combined effect of the members being coupled such that they can be driven simultaneously yet maintain some degree of independent motion relative to one another provides the flexibility to create individualised user experience whilst reducing energy, noise and system complexity (and therefore cost) that would be required if each manipulating member were to be driven independently to allow treatment to be individualised in the manner set out above.

In some embodiments, the manipulating member may be an elongate rod arranged to move in a direction along the length of the rod, wherein the direction along the length of the rod is the axial direction. Other configurations are also possible, for example curved manipulating members which operate in a rocking or reciprocating motion.

The coupled manipulating members may also be substantially parallel to one another, this generally ensures that the force exerted on the proximal end in driving them is applied and distributed evenly between the members. The force exerted by the distal end of the member, or the resistance caused by the tissue around the spine, may also have a predictable response when the alignment of the members is substantially parallel. In addition, this simplifies the driving arrangement, since two manipulating members being both rod-like and arranged parallel and to one another means that both manipulating members can be driven from a first end in an axial direction (that is, along the length of the rod). In other words, a single actuator can drive each of the coupled manipulating members at the same time as each other, by virtue of the coupling, and they can be driven generally in the same axial direction as each other (albeit with an amount of relative axial motion), in order to produce the correct motion for manipulating a user's spine.

The coupling between the proximal ends of the members may optionally be provided by one of a pivoting connection, a resiliently deformable block or a ball and socket joint or any other configuration that allows the members freedom of axial motion relative to each other.

Preferably, a manipulation assembly may be provided by a total of four manipulating members arranged such that they engage four vertebral areas at two locations along the spine on both sides of the spine. The first and second members may be arranged on the same side of the spine and may be coupled together to be driven simultaneously. The opposing third and fourth members may also be arranged to be coupled together and driven simultaneously by virtue of the coupling. The first and third members may act as a non-coupled pair across a first location of the spine, whilst the second and fourth members may act as a non-coupled pair across a second location along the spine from the first location. Whilst being driven in respective coupled pairs, individualised treatment can still be applied by each of the coupled manipulating members by virtue of the way in which they are coupled. Configurations of assemblies with different numbers of manipulating members may also be provided in some examples. In yet further examples, pairs of manipulating members arranged to engage different areas of the spine, for example across the spine, can be driven out of phase or even in exact antiphase.

Advantageously, coupling and controlling the driving of manipulating members on the same side of the spine, as opposed to coupling members about the same spinal or vertebral location, can allow a wide variety of movements to be applied to the muscles and tissue of the spine.

Members arranged in an assembly configuration may be optionally held in place by being mounted on a bracket, which is preferably a Y-shaped bracket. Y-shaped brackets have: a vertical portion supporting a first arm and a second arm; wherein the first arm receives the first and second manipulating members; and the second arm receives the third and fourth manipulating members. The angle which the manipulating members make with the vertical portion of the Y-shaped bracket may be between 30 degrees and 50 degrees. This allows the mounted manipulating members to be angled upwards to be able to engage the spine to both press and massage the tissue about the spine. In an exemplary arrangement, each manipulating member makes an angle of about 40 degrees with the vertical portion of the Y-shaped bracket. The first and second members may be arranged on a first arm of the bracket, and the third and fourth members may be arranged on a second arm of the bracket. In other examples, more or fewer members may be mounted on each arm of the bracket.

In some embodiments, the first, second, third and fourth members may be arranged such that their respective distal ends form a rectangular configuration, which may include a square configuration. Other examples include trapezoidal, rhomboidal and parallelogram arrangements, depending on the specific treatment required by a user. In some examples the arrangement of the tips can advantageously be combined with the relative timing of driving different manipulating members, so as to manipulate vertebrae in a particular manner, for example rocking, twisting and/or dragging motions may be achieved with particular combinations of distal end arrangements and the timing of actuation of each manipulating member relative to one another. Such motions may beneficially massage the tissue to release tension.

Preferably, the first and second manipulating members may be spaced apart by a first distance in a direction along the spine, which is transverse to their axial direction of motion. The third and fourth members may also be spaced apart by the same first distance in the same direction along the spine as the first and second members. The first distance may be calculated centre-to-centre between the manipulating members, and may be between 30 mm and 40 mm, more preferably wherein the spacing is 35 mm. The first spacing may beneficially be tuned according to the distance between adjacent vertebrae, which may depend on both the part of the spine being engaged or the size of the user, such that a more effective treatment can be provided.

Preferably, the manipulating members are spaced apart by a second distance across the spine, wherein the direction across the spine is perpendicular to the direction along the spine. The first and third manipulating members and the second and fourth manipulating members may be spaced apart respectively by the second distance. The distance, also calculated centre-to-centre of the tips of the manipulating members, may be between 50 mm and 80 mm Clearly the linear motion which the manipulating members undergo will change this distance. Therefore, for the avoidance of doubt, this spacing refers to the positions of the manipulating members when they are at rest, i.e. before being actuated to cause their extension towards the intended position of a user's spine.

Optionally, the spacing of the first or second distance may depend on the region of the spine that is being engaged. Preferably, assemblies for treating cervical vertebrae may have a second distance of about 55 mm to 70 mm, whilst assemblies for treating thoracic and lumbar vertebrae may have a spacing of about 70 mm to 80 mm Advantageously, the spacing of the members in an assembly matches the spacing and size of the vertebrae in that spinal region such that the treatment can target localised vertebral areas with improved accuracy. For example, manipulating assemblies for treating cervical vertebrae may have a second distance of about 65 mm and manipulating assemblies for treating thoracic or lumbar vertebrae may have a second distance of about 70 mm.

Further personalisation may be afforded to assemblies in the different regions along the spine such as: differing heights of the assemblies to account for the curvature of the spine; longer or shorter manipulating members with variations in diameter may be used depending on the geometry of the spinous and transverse processes of the particular region of the spine; the Y-shaped bracket may be arranged such that the members engage the spine at a different angle to the vertical in different regions, or indeed at specific locations within a region; the Y-shaped bracket may be configured in a different geometrical orientation; the manipulating members may be mounted with varying degrees of ranges or freedom of axial motion; adaptations in material or size of the components for particularly large, small, heavy or light users may be made; arrangements suitable to treat particular conditions. In some examples, the spacing between adjacent manipulating assemblies (across and/or along the spine) may be adjustable to account for different users' physiology. Indeed, many of the physical dimensions presented herein may be adjustable within their respective ranges to account for physiology. In some cases, the manipulating members for manipulating spinal regions in different areas of the spine are substantially identical to one another, and a different spacing between adjacent members is provided by mounting the members at a different point along their length. In other examples, the members for use in different parts of the spine are simply longer or shorter, thinner or thicker, etc. as required. In yet further examples, the brackets may be different shapes or sizes to hold the manipulating members in the desired arrangement.

Optionally, the elongate rod may have a diameter between 10 mm and 15 mm, more preferably wherein the diameter is about 12 mm. The tip of the elongate rod may be configured to have similar shape and hardness to a fingertip to imitate massage by a masseuse, and may have a diameter of between 5 mm and 10 mm, more preferably about 8 mm.

In some embodiments, the manipulating member, or the elongate rod, may have a pliable pad at its distal end that engages the spine. The pliable pad may be made of a soft rubber or similar material to provide comfort to the user. The hardness of the pliable pad may have a hardness of 60 or less, as measured on the Shore “A” scale. The pliable pad may have a thickness (for example an extent in a distance along the axial direction of the manipulating member) of between 2 mm and 3 mm, preferably wherein the thickness is about 2.5 mm. The shape of the pad may be hemi-spherical or spherical, with a diameter of between 8 mm and 15 mm, for example about 12.5 mm. The pad being spherical provides additional comfort to the user over other configurations whilst also maintaining accuracy. The sizes and thicknesses of the pliable pad given above have been found to be particularly effective

According to a second aspect of the present invention there is provided a manipulating assembly for a spinal therapy device, the manipulating assembly comprising: a first manipulating member arranged to engage a spine at a first vertebral area between a spinous process and a transverse process on a first side of a spine; a second manipulating member arranged to engage the spine at a second vertebral area between a spinous process and a transverse process on a second side of the spine, wherein the second vertebral area is spaced across the spine relative to the first vertebral area; and a drive system for driving the first and second manipulating members; wherein each manipulating member is arranged to be driven by the drive system in an axial direction from a proximal end and having a portion for engaging the spine at a distal end; and wherein the drive system is adapted to drive the first and second manipulating members simultaneously and independently. Manipulating members of the second aspect are comparable to those of the first aspect, in that they have common physical attributes. As such, physical features of the manipulating members discussed in relation to the first or second aspects are interchangeable.

Advantageously, independently addressing the different vertebral areas defined by the transverse processes about the spinous process provides individualised treatment for the user, which may result in greater relaxation of tense or dense tissue. In addition, the ability to drive the manipulating members independently of one another can provide a variety of different motions, such as twisting, dragging, squeezing and rocking motions by actuating the manipulating members independently. In some examples the motion may be periodic with each manipulating member being at a particular part of its cycle at different times to the times where other manipulating members reach that point in their own cycle. As an example, consider the full forward extent of motion, in which a manipulating member is extended as far forward, or towards its distal end, as it goes in a cycle. In some cases one manipulating member may reach its full forward extent, at a time t₀, but another manipulating member may reach its full forward extent some time Δt later, at t₁=t₀+Δt. As set out above, this independent motion can be used to provide a variety of different treatment motions to treat a variety of different conditions.

In some embodiments the manipulating assembly may further comprise a third manipulating member extending substantially parallel with the first manipulating member and arranged to engage the spine at a third vertebral area between a spinous process and a transverse process on the first side of the spine, wherein the third vertebral area is spaced along the spine relative to the first vertebral area; a fourth manipulating member extending substantially parallel with the second manipulating member and arranged to engage the spine at a fourth vertebral area between a spinous process and a transverse process on the second side of the spine, wherein the fourth vertebral area is spaced across the spine relative to the third vertebral area and along the spine relative to the second vertebral area; wherein the third and fourth manipulating members are each arranged to be driven by the drive system in an axial direction from their respective proximal ends and having a portion for engaging the spine at a distal end; wherein the first and third manipulating members are coupled together at their proximal ends to permit the first and third manipulating members to be driven simultaneously (together at the same time and in the same direction); wherein the second and fourth manipulating members are coupled together at their proximal ends to permit the second and fourth manipulating members to be driven simultaneously (at the same time and in the same direction) and independently from the first and third manipulating members. The drive system may comprise a plurality of actuators arranged to drive the manipulating members.

A manipulating assembly of four manipulating members in the second aspect in some cases can be thought of as equivalent to two pairs of manipulating members according to the first aspect. To assist in converting between the two discussions, it should be noted that the first and third manipulating members of the second aspect are equivalent to the first and second manipulating members of the first aspect, and similarly the second and fourth manipulating members of the second aspect are equivalent to the third and fourth manipulating members of the first aspect.

Optionally, the manipulating members of the manipulating assembly may comprise an elongate rod. Other geometries or configurations may be used as set out above.

In some embodiments, the coupling between the first and third members permits axial motion of the first and third members relative to one another and/or the coupling between the second and fourth members permits axial motion of the second and fourth members relative to one another to provide a system whereby the coupled rods may be driven simultaneously, yet maintain a degree of independence by way of a degree of freedom along the axis aligned with that of the axial motion of the manipulating member. The degree of freedom is afforded by the way in which the manipulating members are coupled.

In some embodiments, the drive system is adapted to drive manipulating members on the first side of the spine out of phase with manipulating members on the second side of the spine, optionally wherein the drive system is adapted to drive the manipulating members on the first side of the spine and manipulating members on the second side of the spine in antiphase with one another. The drive system may be arranged to control one or more actuators of coupled manipulating members. The first and third members being provisioned on the first side of the spine and the second and fourth members being provisioned on the second side of the spine. In other embodiments, the manipulating members may be driven in phase. In some embodiments, the members can be driven both in anti-phase and in phase throughout a treatment profile, for varying durations, which may be more effective than driving the members consistently at the same phase. The drive system may be configured to drive the manipulating members with a constant cycle time or with a varying cycle time between the different members, for example to create ripple or wave effects along a user's spine.

The drive system may control assemblies individually and/or in combination with other assemblies. For example, according to a pre-determined program of the spinal therapy device. Different conditions such as Multiple Sclerosis, MS, Chronic Fatigue Syndrome, any form of physical or emotional stress, trapped nerve, etc may be treatable with tailored pre-determined programs. Other examples include programmes specially designed for treating headache, arm or shoulder pain caused by trapped nerve(s) around the neck and shoulder, by focusing on the neck and/or upper back region. Programmes which focus on the lower back may be suitably adapted for treating sciatica or vertebral disc problems.

The manipulating member may be biased in a direction towards its distal end and the drive system may operate to retract each manipulating member by pulling it in a direction towards its proximal end to overcome the biasing. The biasing may be provided by an adjustable biasing system. For example, a spring held under compression, and a screw thread may be used to adjust the compression of the spring to alter the restoring force.

In some embodiments, the drive system comprises: a first actuator for driving the first manipulating member; a second actuator for driving the second manipulating member; and a controller for simultaneously activating the first and second actuators to drive respectively the first and second manipulating members. The controller may control the drive system. For example, an actuator may be provided by a motor and lead screw arrangement. Other driving mechanisms including, for example, pneumatics and/or hydraulics may also be used in some examples. Providing drive systems to drive manipulating members disposed along and across the spine independently provides for individualised treatments along the length of the spine, which may provide a more effective treatment. The first actuator can be arranged to drive the first and third coupled members, and the second actuator can drive the second and fourth members when in an assembly. Additional actuators can be added with additional coupled pairs such that each pair can be driven by the drive system which is controlled by the controller.

In other embodiments, the drive system may comprise a reciprocating actuator and each manipulating member may be connected to the reciprocating actuator by a Bowden cable, to which the first and second members may be connected. In some embodiments, the cable forms a loop, in other embodiments; there may be two Bowden cables. The actuator may be decoupled from its respective manipulating member by a spring. Direct drive decoupling avoids a situation where a motor or other actuator forces the manipulating member into a user's spine; instead the force may be limited by choosing a spring of suitable spring constant. The spring, for example, may be chosen with a spring constant which gives 300N at start of motion, dropping to 140N at the end of the motion. In this case, it also provides the restoring force for the Bowden cables, since Bowden cables are unable to push the manipulating members back towards the user's spine. This inability of a Bowden cable to push makes this a particularly suitable drive system as the drive system can never force the manipulating members into a user's spine with more force than is exerted by the spring, which can be limited to a desired value by choosing a spring of appropriate spring constant.

Optionally, the drive system drives the manipulating members to cause a movement between 12 mm and 35 mm, for example 20 mm in the axial direction. The drive system may drive the manipulating members at a speed between 5 mm/s and 15 mm/s, for example 10 mm/s. These distances and speeds have been found to provide particularly effective treatment.

The manipulating assembly may optionally comprise sensors for detecting a measure of force and/or overextension of the manipulating members. For example, the sensor may utilise the Hall Effect or other proximity sensors. Each patient can have an individualised threshold, within a pre-determined maximum safety extension. Sensors may ensure that treatments conform to a particular regime and/or that particular thresholds may not be exceeded for the avoidance of pain or injury.

According to a third aspect of the present invention there is provided a spinal therapy bed comprising: a chassis; a platform supported above the chassis for supporting a user on their back and having an aperture through the platform for receiving the user's spine; a plurality of manipulating assemblies mounted on the chassis below the platform and extending into the aperture, each manipulating assembly comprising a first pair of manipulating members arranged to engage the user's spine at a first vertebral area between a spinous process and a first transverse process and at a second vertebral area between the spinous process and a second transverse process, wherein the first and second vertebral areas are spaced apart from one another across the spine; a drive system for driving the manipulating members; and a control system for controlling the drive system; wherein each manipulating member is arranged to be driven by the drive system in an axial direction from a proximal end and having a portion for engaging the spine at a distal end; and wherein the manipulating assemblies are arranged into groups; wherein adjacent assemblies in the same group are separated by a distance in a first range; adjacent assemblies in different groups are separated by a distance in a second range; and distances in the first range are smaller than distances in the second range. In some examples, all of the distances of the first range are smaller than any or all of the distances in the second range.

As will be appreciated, a manipulating assembly may comprise manipulating members according to either the first or the second aspect, or in some cases a combination of manipulating members according to the first and second aspects.

This may allow efficient treatment of the whole spine of a variety of patients with fewer motors and/or components. In an alternative, some members may be moveable along the length of the spine for individual patients.

Advantageously, the spinal therapy bed is ergonomically designed for both comfort to the user and effectiveness of the treatment. Manipulating members are arranged in manipulating assemblies, the manipulating assemblies can be spaced such that they are arranged into groups. The spacing of the manipulating members in an assembly, or within a group, may be constant, and may be set to a different distance depending on the group or indeed the assembly. This allows the device to target specific portions of a user's back. As the user is supported by the platform, the user's own weight presses their spine downwards into the aperture. The engaging members can then press into the user's back at specific locations. When driven by the drive system, the manipulating members press into the user's back with varying force to provide personalised treatment.

In some embodiments, the assemblies can be divided into groups comprising: a first group comprising at least one manipulating assembly, wherein an assembly comprises a group of four manipulating members, and arranged to engage vertebral areas in the cervical region of the user's spine; a second group comprising at least one manipulating assembly and arranged to engage vertebral areas in the thoracic region of the user's spine; and a third group comprising at least one manipulating assembly and arranged to engage vertebral areas in the lumbar region of the user's spine. Any combination of one, two or three groups may be used, which may depend on the patient being treated, or the treatment regime of a particular patient. In the scenario where only a cervical group and a lumbar group are present, the gap between the groups will be much larger than the spacing between the manipulating members within the group, and may be around 360 mm, or two times the distance in a second range, plus the distance which the thoracic manipulation assemblies would have occupied. In some cases, the manipulating assemblies may be slidable in a direction along a user's spine to provide varying numbers of manipulating members in each region (i.e. to change the number of manipulating assemblies in each group). For example, it may be possible to slide a manipulating assembly between the lumbar region and the thoracic region of a user's spine or between the thoracic and cervical regions.

The first range of distances, which can be thought of as the centre-to-centre distance between the distal ends of each manipulating member along the length of the spine both between manipulating members forming part of a single assembly (for example two coupled pairs in an assembly) and between adjacent manipulating members in adjacent assemblies, but still within a first group (for example a cervical region), are separated from one another by a distance between 30 mm and 40 mm, for example about 35 mm. The first range of distance or spacing for second and third groups, which may be thoracic and lumbar regions, could be the same, or may be very slightly, for example a few millimetres, different. In each of the groups, the distances both between manipulating members in an assembly (for example two coupled pairs in an assembly) and between adjacent manipulating members in adjacent assemblies are maintained at an approximately constant value. These distances have been found to be particularly effective for an average patient but may be altered according to individual needs or requirements.

The second range of distances, which can be thought of as the distance between the groups, and is generally a larger distance than the first range of distances, may be between 80 mm and 110 mm, for example about 105 mm and may depend on the user's height. As mentioned above, the distances between members and between groups can be adjustable in some examples to account for differences in user physiology.

Optionally, the manipulating members of the assemblies in the groups comprise an elongate rod.

Preferably, the first pair of manipulating members of each manipulating assembly is arranged to engage the spine across a first vertebral area and the second pair of manipulating members are arranged to engage the spine across a second vertebral area adjacent to the first vertebral area. In certain embodiments, there may be up to a total of 24 manipulating members spaced along the length of the spine, advantageously arranged to maximally address the spine. It will be appreciated that a spinal therapy bed may have any number of manipulating members.

A first group of, for example, two pairs of manipulating members, which may form an assembly of four linked manipulating members as described above may be arranged to engage the cervical region. A second group of, for example, six pairs of manipulating members (or three assemblies), may be arranged to engage the thoracic region. A third group of, for example, four pairs of manipulating members (or two assemblies), may be arranged to engage the lumbar region. Other example groups and group sizes and indeed other numbers of manipulating members in an assembly may also be used. Optionally, each manipulating assembly may comprise a second pair of manipulating members positioned to engage the spine along the spine from the first pair of manipulating members, wherein the second pair of manipulating members may be spaced along the spine a distance between 30 mm and 35 mm from the first pair of manipulating members, for example the distance is about 33.4 mm.

Manipulating assemblies may include a Y-shaped bracket for supporting the manipulating members, the bracket having: a vertical portion supporting a first arm and a second arm; wherein the first arm receives a first manipulating member of the pair of manipulating members for engaging a first side of the spine; and the second arm receives a second manipulating member of the pair of manipulating members for engaging a second side of the spine. A Y-shaped bracket is particularly advantageous because it provides stability for a number of members, which may be on opposing sides of the spine, and also allows the members to be disposed at an angle such that they can press into and massage the tissue in the vertebral area.

Optionally, the vertical portion of each bracket, which may be a Y-shaped bracket, is adjustable to change a distance which the corresponding manipulating assembly extends into the aperture (that is the adjustment raises or lowers the Y-shaped bracket relative to the chassis). The vertical portion of the bracket may be configured at different heights (i.e. spacing from the chassis in the direction of the expected location of the user's spine) along the bed to account for the natural curvature of the spine. In the cervical region, for example, it may have a length of around 220 mm and in the thoracic and lumbar regions it may have a length of 180 mm. The cervical region may, in general, be positioned higher than the lumbar and thoracic regions so as to support the neck area in a more natural and comfortable position. The diameter of the support shaft may be 25.1 mm, and it may have a D-shaped cross-sectional area that is shaped to prevent rotation of the support head. Other cross-sectional area shapes may also be used, for example circular. The vertical portion of each bracket may also be individually adjustable to change a distance which the corresponding manipulating assembly extends into the aperture. Beneficially, this may be used to account for the curvature of the spine or the degree of therapy required.

Preferably, the drive system of the spinal therapy bed comprises an actuator, which may be configured to drive each manipulating assembly, or which may be configured to drive each manipulating member within an assembly.

In some embodiments, the drive system may comprise a drive assembly for each respective manipulating assembly, each drive assembly comprising: a first actuator for driving a first coupled manipulating member pair of an assembly; a second actuator for driving a second coupled manipulating member pair of the assembly; wherein the control system simultaneously activates the first and second actuators to drive respectively the first and second manipulating members. In other embodiments, the pairs of manipulating members can be independently activated by the drive system. A controller may control the manner in which the drive system activates the actuators. In some embodiments, the drive system, controlled by the controller, can be configured to drive the spinal therapy device comprising a number of drive assemblies according to a predetermined program.

The actuator may advantageously be mounted on the Y-shaped bracket to mechanically isolate it from the chassis, so as to inhibit transmission of mechanical vibrations from the actuator to the chassis. Beneficially, inhibiting transmission of vibrations to the chassis ensures that separate or adjacent assemblies and/or manipulating members are capable of independent manipulation, and are not influenced by contributory external environmental factors. It also helps to keep the sound levels to a minimum.

Optionally, the drive system may comprise a drive assembly for each respective manipulating assembly, each drive assembly comprising: a reciprocating actuator; and each manipulating member of the pair may be connected to the reciprocating actuator by a Bowden cable. In certain embodiments, the first and second manipulating members of the pair are connected to the same Bowden cable. The Bowden cable may be arranged to form a loop but in other situations may be separate.

The reciprocating actuator may be mounted on the chassis and may also be mechanically isolated from the chassis, so as to inhibit transmission of mechanical vibrations from the reciprocating actuator to the chassis.

Preferably, each actuator of the spinal therapy device may be independently controllable by the control system. Optionally, actuators may be decoupled from their respective manipulating member by a spring. Each manipulating member may be further configured to be biased in a direction towards its distal end and the drive system may be configured to operate to retract each manipulating member by pulling it in a direction towards its proximal end to overcome the biasing. The biasing may be provided by an adjustable biasing system.

In some embodiments, the drive system may drive the manipulating members to cause a linear movement along an axis of the member between 12 mm and 35 mm, for example about 20 mm which may be driven at a speed between 5 mm/s and 15 mm/s, for example about 10 mm/s. Such distances and speeds have been found to be particularly effective; however, individualised treatments may be desired by different patient, or, for example, different medical conditions such as Multiple Sclerosis, MS, Chronic Fatigue Syndrome, any form of physical or emotional stress, trapped nerve, etc. In some examples, some specific treatment programs may focus on the lower back, for example for treating sciatica or vertebral disc problems. Other programmes may be designed for treating headache, arm or shoulder pain caused by trapped nerve(s) around the neck and shoulder, by focussing on the neck and/or upper back region.

Certain embodiments comprise sensors for detecting overextension of the manipulating members. The sensors may be Hall Effect sensors for example. The sensor can be linked to a cut switch, at least for that actuator, if the sensor determines that a threshold (for example: speed, distance, force) has been reached. Each patient can have an individualised threshold, within a pre-determined maximum safety extension.

The platform of the spinal therapy device may be arranged with a padded upper surface, which may be comprised of foam or other materials that are comfortable for the user to lie on for the duration of the treatment. The profile of the foam may be shaped for comfort. In some embodiments, a profile of the shaped foam may have sloping walls forming a V-shape or sloping walls with a horizontal base portion joining the lower edge of the sloping walls. Either arrangement can make it easier for a user to correctly position themselves on the device. The aperture of the spinal therapy device, where the manipulating members are arranged to be, may be positioned or located in the lowest point of the V or in the horizontal base. The sloping walls of the V-shaped configuration may make an angle of between 15° to 25° with to the horizontal, more specifically wherein the sloping walls may make an angle of between 15° and 25° to the horizontal, which advantageously provides comfort and support to the user.

In certain embodiments, there is provided a modular assembly for forming the spinal therapy bed comprising: a chassis having mounting locations spaced along a length of the chassis; a platform supported above the chassis for supporting a user on their back and having an aperture through the platform for receiving the user's spine; a plurality of manipulating assemblies for mounting below the platform and extending into the aperture on the chassis at the mounting locations, each manipulating assembly comprising a first pair of manipulating members arranged, once mounted, to engage the user's spine at a first vertebral area between a spinous process and a first transverse process and at a second vertebral area between the spinous process and a second transverse process, wherein the first and second vertebral areas are spaced apart from one another across the spine; a drive system, mountable to the chassis or the manipulating assemblies, for driving the manipulating members; wherein the mounting locations are spaced such that adjacent manipulating members in a group are separated by a distance within a first range; and the mounting locations are spaced such that adjacent groups of manipulating members are separated by a distance within a second range; wherein distances in the first range are smaller than distances in the second range.

According to a fourth aspect of the present invention there is provided a method of control for a spinal therapy bed, the spinal therapy bed comprising: a plurality of manipulation members, each manipulating member arranged to engage a user's spine at a respective vertebral area between a spinous process and a transverse process and comprising an elongate rod arranged to be driven in an axial direction from a proximal end and having a portion for engaging the spine at a distal end; and a drive system; wherein the method comprises: controlling the drive system to actuate the manipulating members to apply pressure to their respective vertebral areas, wherein a plurality of the manipulation members are driven simultaneously and independently.

In some embodiments, the spinal therapy bed may further comprise sensors for monitoring the behaviour of each manipulating member and wherein the method includes: receiving measurements from the sensors, the measurements comprising at least a measurement indicative of a force, motor current fluctuations, for example, applied by at least one manipulating member over a cycle in which the manipulating member moves towards and away from its respective vertebral area and returns to its starting position; and adaptively adjusting the force applied by each manipulating member in response to the received measurements. Machine learning techniques may be used to develop a bespoke treatment regime for each individual, which may be based on the measurements made by the sensors during the treatment.

Advantageously, adaptive adjustment allows a user to receive a personalised treatment, which is responsive to the density of the tissue that is being manipulated or indeed that is specifically designed to maximally relieve tension of the user.

Optionally, the spinal therapy bed may further comprise sensors for monitoring the distance travelled by each manipulating member and wherein the method includes: receiving measurements from the sensors, the measurements comprising at least a measurement indicative of a distance travelled by at least one manipulating member over a cycle in which the manipulating member applies a time varying force to its respective vertebral area; and adaptively adjusting the motion of each manipulating member in response to the received measurements.

In some examples, applying the force comprises changing a control variable: receiving a profile of the control variable over the cycle; identifying a threshold value of the control variable from the profile, wherein the threshold value is indicative of a time at which a statistically significant change in the control variable is determined; and controlling the drive system based on the threshold value. The control variable may be one or more of current, power, voltage drawn by an actuator or other measurable quantity associated with the driving of the members. The threshold value may be indicative of a boundary between soft and dense tissue, for example, or that the tissue has been compressed against a rigid backing material (e.g. bone).

A threshold value indicative of a time before a spike in current (or another feature such as voltage, power or force) of the motor may be found by collating data, for example continuously, across a number of cycles of the treatment regime or throughout the entire treatment regime. Analysis of this data may be used to predict the point at which the manipulating member penetrates more dense tissue before reaching bony mass of the spine itself. By monitoring, predicting and accounting for this threshold, which is expected to gradually change over the course of the treatment as the tissue relaxes, injury or discomfort may be prevented. The threshold value may be indicative of the relative firmness of the tissue around the vertebral areas which the manipulating members are addressing, and the treatment regime may be adaptively developed based on the indication of the relative firmness. In some cases the reading of current or other variable such as voltage, power, etc. over time may show two distinct phases, a first phase having a first gradient, and a second phase having a second gradient. The second gradient may be higher than the first gradient. In some cases, a high gradient is indicative of a manipulating member being driven with high power, i.e. to exert a large force. In some examples a threshold may be determined by monitoring a gradient of a current reading (that is a derivative with respect to time), and activating a safety cut out when a threshold value is detected. Sharp increases in gradient can be indicative of a system no longer pushing into muscle, but pushing into bone structures, which is not usually helpful in treating patients with back problems.

In some embodiments, the treatment regime may include: distances for each manipulating member to extend during treatment; forces for each manipulating member to exert during treatment; and/or relative start points for each manipulating member, for example for adapting to a physical profile of the spine.

Optionally, asynchronous or independent driving includes: a rippling motion with a constant phase between adjacent manipulating members; adjacent manipulating members being driven in antiphase; and/or different motions in cervical, thoracic and lumbar portions of a user's spine. Such motions may create an overall rocking, twisting, rippling or other motion of the user.

The spinal therapy bed may include an adjustable leg support and the method may further include adjusting the height of the adjustable leg support at specific timings during a treatment process for increased comfort of the user and greater accuracy of treatment. The raising of the leg support may also be used to reposition the spine or change weight distribution at different points of the treatment.

Optionally, the drive system may be fitted with a cut out switch operable to stop the driving system from driving one or more manipulating members if an actuator draws more than a threshold value of current, voltage or power and prevents a manipulating member from being driven into the back of the user, which may be uncomfortable.

According to a fifth aspect of the present of the present invention, there is provided a method of control for a spinal therapy device, the method comprising: determining control signals for controlling a plurality of manipulating members of the spinal therapy device based on a stored treatment profile, wherein the manipulating members are arranged to engage a user's spine at a respective vertebral area between a spinous process and a transverse process; applying the control signals to drive the one or more manipulating members in at least one cycle to implement a treatment regime; receiving feedback signals from a plurality of sensors for monitoring the behaviour of each manipulating member indicative of a pressure and/or movement applied on a user's spine by the plurality of manipulating members during the at least one cycle; and determining adjusted control signals based on the control signals of the stored treatment profile and the received feedback. The stored treatment profile may be stored locally (on a control system of the device, for example) or remotely and the treatment regime may comprise a number of cycles. The cycle may refer to one complete circuit of each of the manipulating member of the device moving from a rest position and returning to that rest position, or a cycle may refer to a series of movements of the manipulating members in a defined manner to be repeated in subsequent cycles.

Advantageously, determining adjusted control signals from feedback signals provided by the sensors throughout the treatment regime can allow personalised treatments to be determined both during the treatment and for later treatments. It can also allow for improved patient treatment in general or for treatments specific to a user. Treatment profiles may be stored with the adjusted control signals such that when the patient returns, or the next patient arrives, the treatment profile has been optimised and is ready to provide instruction for a subsequent treatment. The adjusted control signals may be indicative of how long it takes tissue to relax in specific users, or which motions are particularly effective at releasing tension, such that subsequent treatment profiles can be designed according to received feedback.

A treatment profile may specify parameters including one or more of: total length of treatment or lengths of particular stages or cycles within the treatment, distance of manipulating member to travel in one movement (which may change, or dynamically change, throughout a treatment), operating speed of a manipulating member (which may also change throughout a treatment); motions (e.g. ripple, twist, squeeze, rock) to be performed throughout the treatment and, optionally, instructions on how to achieve these motions using the plurality of manipulating members; duration and sequences of motions; force/pressure to be applied to the spine; and/or other parameters which can be controlled by a central unit or control system.

Adjusted control signals may advantageously be determined using machine learning algorithms. The feedback signals may be collated and analysed, for example, using machine learning techniques, and may generate adjusted control signals based on the received feedback.

In some examples the adjusted control signals can be applied in the next cycle, which may be one of a plurality of cycles in a treatment regime. The treatment regime or treatment profile may be generated or updated, for example continuously or dynamically updated, based on the adjusted control signals, which may be influenced by one or both of feedback signals and data collected from previously executed methods on one or more components of the drive system which perform actuation of the manipulating members. Feedback data from signals may be collected from users, for example at a central unit or memory, over one or more treatments, which may optionally be used to update treatment profiles.

Adjusted control signals may specify, for example, an adjusted speed or range of extension with which to drive the manipulating members. The adjusted control signals may be adjusted as the tissue around the engaged area of the spine is relaxed, for example by reducing the power or force of the members into the back. The signals may also specify, for example, that groups at different regions along the spine are to be turned off once a desired relaxation of the tissue has been achieved. Differing parameters can be applied along the length of the spine depending on the relative stiffness of the area that is being manipulated, and adjusted control signals may reflect this.

In some examples the method may be stored as a new treatment profile based on the updated treatment regime, which may replace the previously stored treatment profile or be stored as a new treatment profile, or form part of a series of personalised treatments specific to a user.

Treatment profiles are optionally stored in a library or database of selectable treatment profiles. The library may comprise general profiles and/or personal treatment profiles for a specific user based in part on feedback signals from the user. General treatment profiles may comprise, for example, pre-determined treatments which may be designed to treat particular conditions or which may form part of a series of recommended treatment profiles or which may have been optimised based on analysis of a number of treatments on a plurality of users. Personal profiles may be determined based on a selected general profile that has been adapted for the individual based on previous or manually entered settings or treatments. Treatment profiles for treating a specific condition, or conditional treatment profiles, may also be developed based on data collected from users with that condition. Other profiles might be aimed at achieving particular results, identified by statistical analysis of previously performed treatments.

The library may be stored on a central server, which may be stored in a virtual or physical server and may be accessible by a wired or wireless connection, for example via the internet. The central server may have a memory in which to store treatment profiles and a processor with which to receive and process signals, and may be incorporated with the spinal device architecture or be remote. The central server may be accessible from a number of distributed geographical locations such that spinal therapy devices in different locations may be provided with the same treatment profiles. Treatment profiles may be downloadable from the central server directly to the spinal therapy device being used, or by a number of independent steps. Personal treatment profiles may be stored centrally so that a user's personalised treatment details can be accessed from any location and applied to the spinal therapy device in that location, beneficially meaning that the user can experience personalised treatment from anywhere.

General treatment profiles for a spinal therapy device may be generated using a method, the method comprising: receiving at a first plurality of spinal therapy devices, a first treatment profile from a library comprising a plurality of treatment profiles; performing, the method of controlling the spinal therapy device according to the fifth aspect of the invention using the first treatment profile as the stored treatment profile; receiving by a central unit, feedback signals from the plurality of spinal therapy devices; processing by the central unit, the feedback signals to determine a general treatment profile to be used in a subsequent treatment; and storing the general treatment profile in the library.

This method may be performed on each or any of the treatment profiles in the library such that a plurality of general treatment profiles can be generated based on performing the above method on multiple treatment profiles, or all the treatment profiles, in the library. A plurality of different users may be treated with one or more of the treatment profiles in the library. General profiles may be updated, for example dynamically updated, after each iteration of a selected treatment profile or during execution of the treatment profile.

Processing the signals preferably comprises using machine learning algorithms to analyse the volumes of data and/or determine statistics based on received feedback signals. Optionally, the library may be stored on a central server, wherein the server is accessible to provide a stored treatment profile to a spinal therapy device at one of a plurality of locations. The locations may be spaced apart by a range from around a few meters, for example within one treatment centre, to locations which may be on different sides of the Earth.

Preferably, received feedback signals are received anonymously at the central unit to protect the identity of the users whose data may be used to generate adjusted control signals at the control unit where it is processed. Feedback signals may be provided or received anonymously, without revealing the identity of the user, such that the patient remains anonymous, which may be important for confidentiality reasons. Personal data, which may be personal, and not anonymous, may also be stored separately under personal treatment profiles, and may be securely stored.

In a further aspect of the invention, there is provided an apparatus for performing the method according to the fifth aspect of the invention, the apparatus comprising a spinal therapy device, a processor operable to perform the method according to the fifth aspect of the invention and a memory capable of storing the instructions for performing one or more treatment profiles. The memory and processor may be incorporated in the spinal therapy device or can be stored at a central location, for example at a remote server, which may be separate and distant from the spinal therapy device.

For the avoidance of doubt, features presented in one aspect may be applied to other aspects as disclosed herein. In particular, features of the manipulating members described in the first and second aspects should be understood to be interchangeable with regard to their physical attributes. Additionally, a manipulating assembly comprising four manipulating members (or two pairs of manipulating members) in the first and second aspects should be understood to be equivalent to one another and also to the manipulating assembly of the third aspect.

Aspects of the invention will now be described in detail with reference, by way of illustration only, to the accompanying Figures, in which:

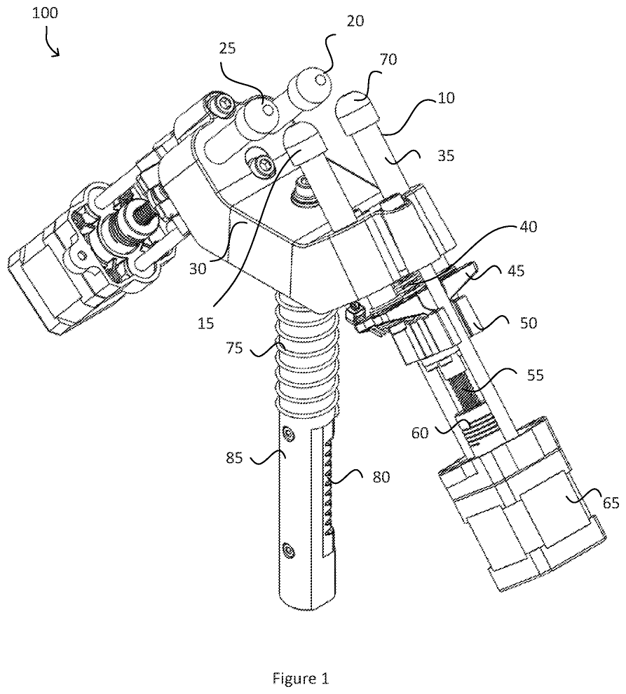

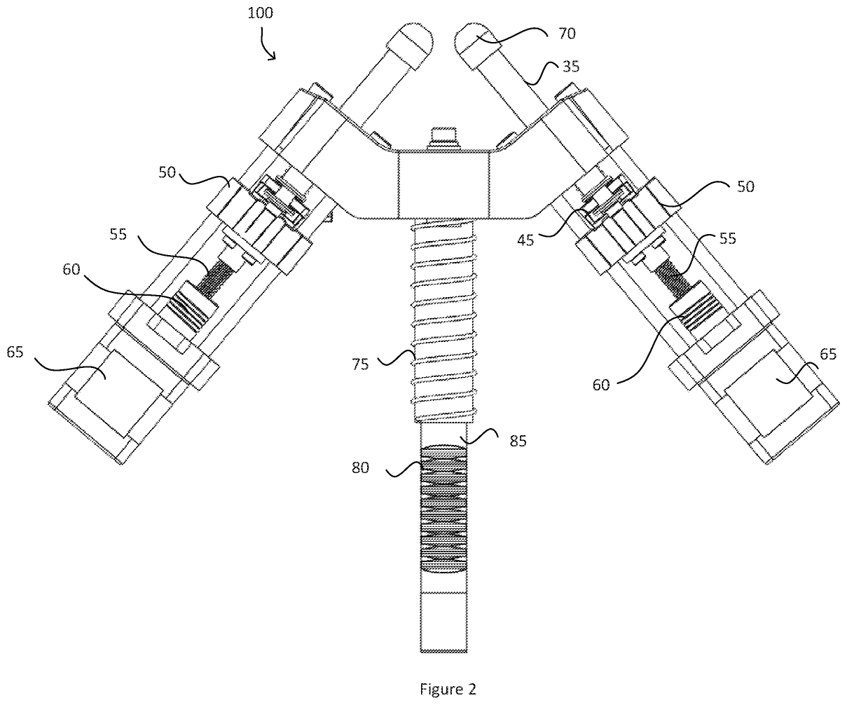

FIGS. 1 and 2 illustrate one of a plurality of manipulating assemblies that form part of a spinal therapy device of an embodiment of the present invention.

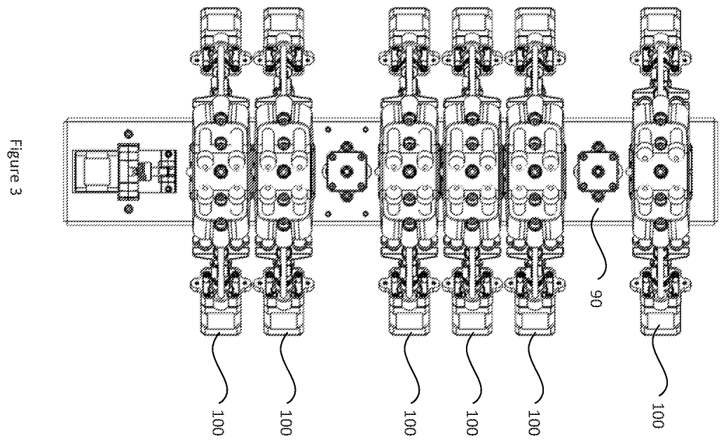

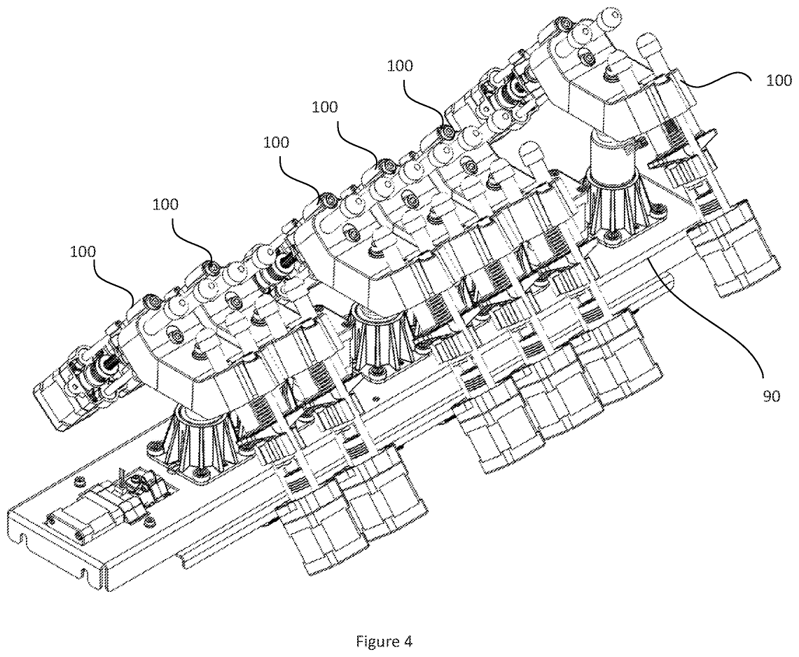

FIGS. 3 and 4 illustrate an embodiment of the present invention.

FIG. 5 illustrates the movement of a Bowden cable bracket driven by a reciprocating actuator.

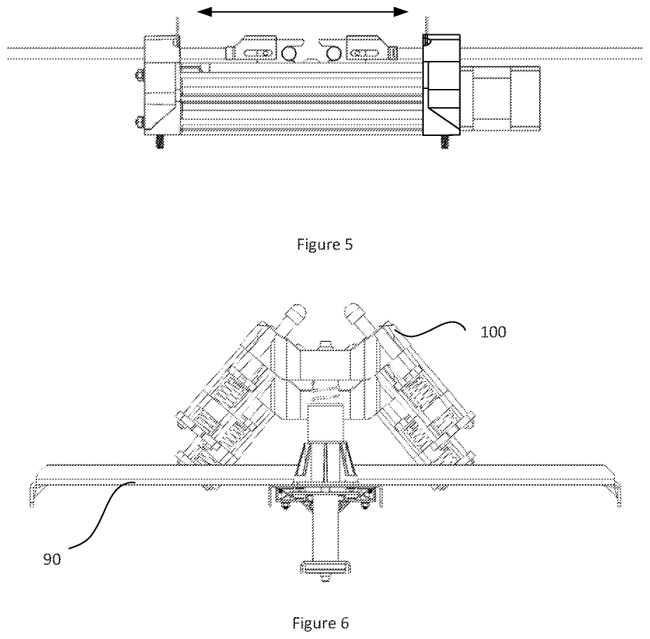

FIG. 6 illustrates a section of an embodiment of the present invention.

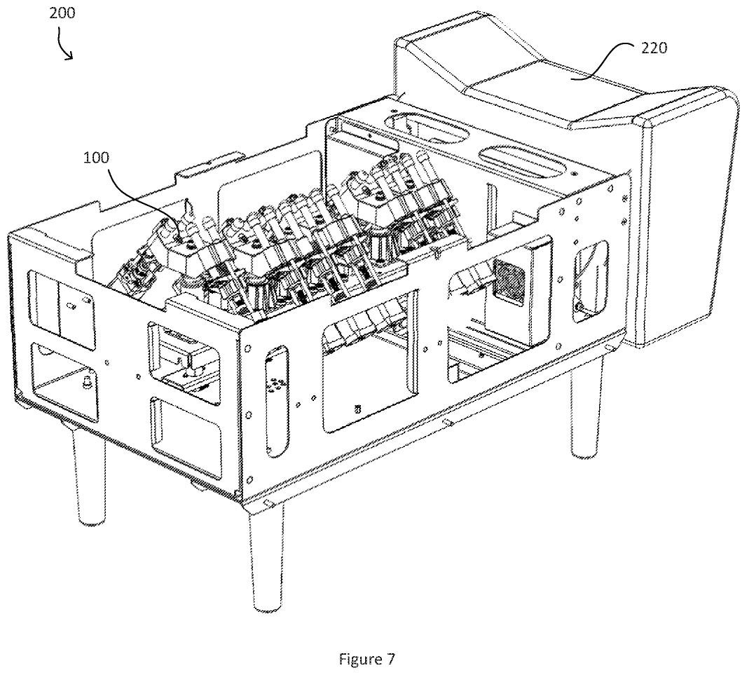

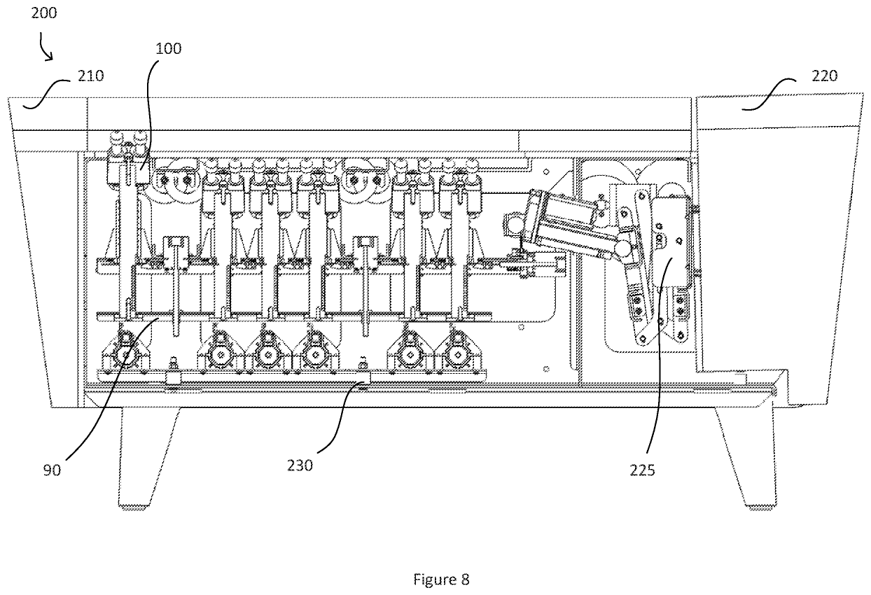

FIGS. 7 and 8 illustrate a massage table frame comprising an embodiment of the present invention.

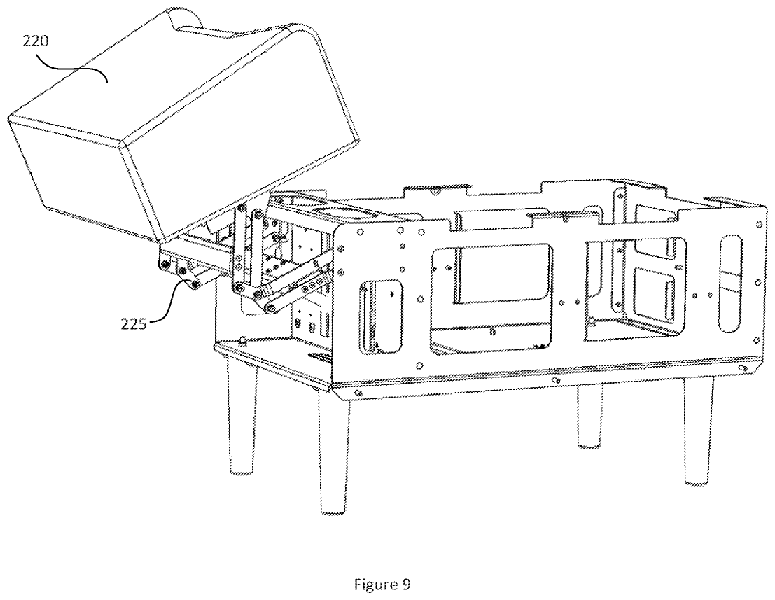

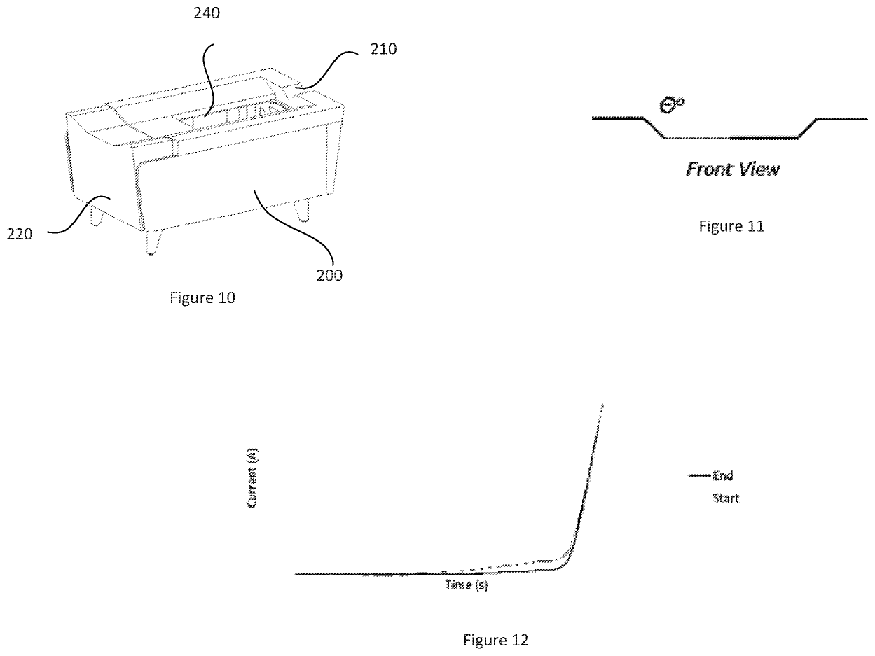

FIGS. 9 and 10 illustrate elements of a massage table for an embodiment of the present invention.

FIG. 11 illustrates a cross section of the spinal therapy bed highlighting an angle relevant to user comfort in certain embodiments.

FIG. 12 illustrates a graph showing current applied to manipulating members against time.

The present invention comprises the application of one or more forces or pressures applied by a plurality of manipulating members to the soft tissue located adjacent each side of the vertebral column in the vertebral area between the spinous and transverse processes. The one or more forces are applied partially towards the base of the area between the spinous and transverse processes and partially towards a second side of the vertebral column opposite the first side such that a substantial length of vertebral column is rotated or rocked by the action of said forces on a plurality of vertebral areas between the spinous and transverse processes, wherein the plurality of vertebral areas may experience different applied forces caused by an imbalance of tension in said vertebral area.

To create movement of the spine, the area of the spine between the spinous and transverse processes should be engaged. This can be achieved by coordination of manipulating members such that they are configured to act as a pair, contacting both sides of a vertebral area about the spine. A substantial amount of force may be required in persons with stiff back problems, or indeed varying forces may be desired at locations with varying levels of tension along the length of the spine.

The aim of the apparatus is to create movement of the spine to cause the vertebral junctions to loosen up and relieve tension. The vertebrae of the spinal column may be required to be independently articulated to accommodate for the differences in physical stiffness or tension in each individual junction along the length of the spine.

Loosening of the vertebral junctions can be achieved by articulating a plurality of manipulating members at each vertebrae, one member on each side of the spinal column, such that a set of manipulating members may be independently operated to achieve a personalised treatment profile that can be adapted to treat variations both along a spine and for any spine.

The movements are applied uniformly, gradually, firmly and over prolonged periods of time. A suitable frequency of movements lies in the range of about 6 to 10 movements per minute, although other frequencies may also impart benefits.

Although a reasonably substantial amount of force is often required, caution must be exercised not to apply excessive force in local points so as to not cause bruises, pain, excessive discomfort or to further inflame an existing injury.

Individually addressing each articulating or manipulating member of a set of members that are required to manipulate the full length of the spine requires intensive energy and resource use to operate the members at each desired intensity for the particular location of the spine that the member is addressing.

The present invention provides a device for manipulating the vertebrae using a plurality of manipulating members that can be individually addressed whilst coupling adjacent manipulating members such that they may be addressed as a coupled pair but have a degree of relative movement, using a single motor to drive the coupled pair, rather than being individually addressed. Advantageously, this reduces the energy used and audible noise in use, as well as streamlining the device, whilst maintaining a fully individualised massage treatment experience for the user.

The present invention provides a number of advantageous features that allow spinal therapy to be performed. These features are provided by manipulating members in a manipulating assembly comprising a means for coupling the members such that relative movement between them can be achieved such that two manipulating members can be addressed at a proximal end using a single driving source to drive the coupled members whilst providing personalised treatment at a distal end; a spinal therapy bed configured to address particular regions of the spine by virtue of the spacing of manipulating assemblies; a “floating” motor that provides control of the manipulating members and ensures that the force exerted on the spine does not exceed a threshold that may cause pain or damage to the user and which does not transmit vibrations to the chassis, so is quieter and more comfortable; and a method of controlling the spinal therapy bed that provides a personalised treatment.

Referring to FIG. 1 and FIG. 2, an apparatus according to an embodiment of the present invention is described herein.

A manipulating assembly 100 comprises an assembly including a first manipulating member 10, a second manipulating member 15, a third manipulating member 20, and a fourth manipulating member 25, mounted together, each of which may be configured to engage the spine at a different vertebral area and may each be independently addressable and controllable.

Each of the members in the assembly comprises an elongate rod 35, which has a cap 70. The rod can be made from a material that is suitably strong and resistant to deformation yet reasonably lightweight, such as stainless steel. The elongate rod may have a diameter between 10 mm and 15 mm, more preferably wherein the diameter is about 12 mm. The tip of the elongate rod is configured to have similar shape and hardness to a fingertip and has a diameter of between 5 mm and 10 mm, more preferably about 8 mm. The cap may be rubber or another material that is pliable and provides a cushioned interface between the spine and the elongate rod 35. The cap may have a diameter of 12.5 mm and a thickness of 2.25 mm. The pliable pad may have a hardness of 60 or less, as measured on the Shore “A” scale. The elongate rod 35 moves linearly along an axis defined along the longer side of the rod, along its centre, the movement being controlled by an actuator comprising a motor 65, a coupling 60 and a lead screw 55. A lead screw 55 translates the rotational motion of the motor 65 to linear movement, which moves the manipulating members to which it is coupled up and down along the axis of the elongate rod 35 such that the manipulating members penetrate the vertebral area at an angle of 50 degrees to the horizontal defined by the orientation of the supporting head 30. It will be appreciated that other actuating means including pneumatic, hydraulic, spring decoupled designs, and Bowden cable driven designs may be used to drive the coupled manipulating members, some of which are described in detail below. Indeed any suitable actuator may be used, many of which will be familiar to skilled workers in the field

Distances between the manipulating members in an assembly vary depending on the spinal region which they are designed to treat. A distance between the manipulating members shown in FIGS. 1 and 2 that address areas across the spine from each other is between 50 to 80 mm and depends on the area of the spine which is being treated. In the cervical region, the distance is between 50 and 70 mm. In the thoracic and lumbar regions, the distance is between 65 and 80 mm. The distance is measured from a centre of the cap 70 on a first manipulating member to the centre of the cap 70 of the manipulating member on the second side of the spine. A distance measured centre-to-centre between the caps of the fingers in a direction along the spine is typically a similar distance in all of the regions, and is about 35 mm. The first and second manipulating members may be spaced apart by a first distance in a direction along the spine, which is transverse to their axial direction of motion. The third and fourth members may also be spaced apart by the same first distance in the same direction along the spine as the first and second members. The first distance may be calculated centre-to-centre between the manipulating members, and may be between 30 mm and 40 mm, more preferably wherein the spacing is 35 mm. In adjacent assemblies in a same group, the distance between manipulating members measured centre-to-centre along the length of the spine between the caps is the same, even between non-coupled members.

The drive system may comprise a drive assembly for each respective manipulating assembly, each drive assembly comprising: a first actuator for driving a first manipulating member pair; a second actuator for driving a second manipulating member pair; wherein the control system simultaneously activates the first and second actuators to drive respectively the first and second manipulating member pairs. In some embodiments, the drive system can be configured to drive the spinal therapy device comprising a number of drive assemblies according to a predetermined program. For example, an actuator may be provided by a motor and lead screw arrangement. Other driving mechanisms including pneumatics or hydraulics may also be used in some examples.

A spring 40 is placed between the pivoting member 45 and the support head 30. The spring allows the assembly to smoothly return to a start or rest position. If the assembly is forward driven, as in FIGS. 1 and 2, and the spring has a high spring constant, the spring 40 could also be used to provide a certain resistance against the members being pushed too hard or too fast into the back of the user, i.e. to provide a degree of protection to the user from overextension of the manipulating members.

In one example of a full cycle of the motor drive, the elongate rod 35 is linearly driven forwards from a resting position by a displacement of about 20 mm in the direction of the user's back then returns backwards to the resting position, aided by the spring 40.

The frequency of the linear movements of the elongate rod caused by the configuration of the motor 65, the coupling 60 and the lead screw may be between 3 Hz and 6 Hz, more preferably 4 Hz. Manipulation of the tissue of a user resting on the manipulating members preferentially causes relaxation and loosens the vertebral junctions.

The first member 10 and the second member 15 are coupled together at their respective proximal ends by virtue of a pivoting member 45 and are driven as a couple in the same direction and at the same time. The members are arranged such that they address a first side of the spine at adjacent vertebral areas. The pivoting member 45 is a swivel bracket, as shown in FIGS. 1 and 2, arranged to pivot about a centre-point between the first and second members. The pivoting member 45 is supported by a bracket 50, which drives the assembly in response to the actuator and provides a backstop that stops the swivel bracket from pivoting too far. The first and second members are spaced apart by a distance of about 33.4 mm.

A stopper 70 provides a soft interface between the elongate rod 35 and the pivoting member 45. This allows for a degree of rocking of the members to distribute load evenly on the user's back for individualised treatment and to protect against jolting movements which may be uncomfortable or cause injury or damage the device. The stoppers 43 shown in FIG. 1 comprise rubber grommets, but other similar configurations may be used to provide this effect.

The pivoting member 45, driven by the actuator, is pivoted by a difference in resistance of the manipulating member against the user, caused by a difference in tension or stiffness inherent to the tissue around vertebral junctions. If there is a resulting difference in the force applied to the elongate rods 35 of the first and second members by the interaction between the spine and the manipulating members, a differing range of motion of the adjacent first and second members may be experienced. For example, if the first member 10 is manipulating an area that is particularly stiff or tense, it may have a restricted range of movement compared to a second member 15 that manipulates an area that is less stiff or tense. This will cause the pivoting member 45 to pivot about the central point between the members, such that the range of motion of the second member 15, in synchronicity with the movement of the members by the actuator, is greater than that of the first member 10. The pivoting may be resisted or limited by elastic materials, springs, frictional bearings, etc. to alter the response of the pivoting member 45 to tissue stiffness differentials. This can help ensure that the relative axial motion of a coupled pair of manipulating members 10, 15 is appropriate in response to particular tissue stiffness differentials.

A third manipulating member 20 is positioned on a second side of a vertebral area to the first manipulating member 10, such that they form a pair about the same vertebral area or around a single vertebra. This pair may be advantageously controlled to manipulate the same vertebral area from each side of the spine in a personalised manner, which may be synchronous or asynchronous.

A third manipulating member 20 and a fourth manipulating member 25 are coupled in the same way as the first member 10 and the second member 15 and are arranged to address a second side of the spine across from the first side.

An assembly of the four members addresses both sides of the spine at two vertebral areas, wherein the first and second members are arranged to engage one side and the third and fourth members are arranged to engage the other side; and wherein the first and third members address a first vertebral area and the second and fourth members address a second vertebral area.

The first, second, third and fourth members are assembled in a manipulating assembly 100 as shown in FIGS. 1 and 2. The members are supported and grouped together by a supporting head 30, which forms part of a Y-shaped bracket, comprising a support shaft 85 and the supporting head 30. The angle at which the members manipulate the spine is defined by the Y-shaped bracket, which can be in the range of 40 degrees and 60 degrees preferably where the angle of treatment is 50 degrees relative to the horizontal axis, or equivalently, around 40 degrees to the vertical axis and/or the leg of the Y-shaped bracket.

By virtue of the support head 30, and Y-shaped bracket in general, the number of parts of the assembly is reduced, which beneficially reduces manufacturing time and cost. It also provides a greater surface area of a platform for load bearing of the user or patient.

The supporting head 30 provides a greater surface area for taking the load of the user with respect to the manipulating members, helping to prolong the lifetime of the spinal therapy device and providing further comfort to the user. The members are able to move independently of the supporting head 30 and each other. They are arranged in a square or rectangular configuration and are evenly distributed about the central point of the Y-shaped bracket.

The manipulating members interact with the supporting head 30 which provides positional support but allows the members to move with a degree of freedom in the axis along the centre of the elongate rod 35, for example as shown in the Figures each manipulating member is arranged to slide through a respective aperture in an arm of the Y-shaped bracket.

The support shaft 85 onto which the support head 30 is mounted is provisioned with a retraction spring 75 and/or a plurality of locking slots 80. The retraction spring 75 provides greater flexibility of the assembly positioning on the support shaft 85. The plurality of locking slots 80 allow the manipulating assembly to be arranged at a personalised height. Adjacent assemblies may be provided at different heights to adjust for the curvature of the spine. This ensures the manipulating members maintain contact with the vertebral areas of the spine along the full length of the spine to improve the effect of the massaging and may also increase the comfort of the user.

The locking slots 80 can have a number of increments for individualised user experience. Configurations with greater or fewer numbers of increments are also possible. The slots are designed to be angled so that the locking plate that connects with the slot pushes inwards and upwards to maintain a connection with the user's back during locking. The edges of the locking slots are angled to allow smooth and controlled entry of height setting pins to avoid sharp or jolting movements.

For different regions of the spine, the support shaft 85 has different lengths. Where the manipulation assembly interacts with the neck, for example in the cervical region of the spine, the support shaft 85 has a length longer than the length of the support shaft 85 along the upper and lower back, for example the thoracic and lumbar regions. For example, the support shaft in the neck region may have a length of 217.5 mm and the length of the support shaft 85 in the upper and lower back regions may be 177.5 mm. The diameter of the support shaft 85 may be 25.1 mm, and it may have a D-shaped cross-sectional area that is shaped to prevent rotation of the support head 30. It will be appreciated that other dimensions and configurations may be possible.

The support shaft 85 may also provide a means for rotation of the manipulating assembly to provide further personalisation for users with spinal curvature.

In other configurations, not shown in the Figures, the swivel bracket that forms the pivoting member 45 may alternatively be a resiliently deformable block or a ball and socket joint for improving individualised treatment.

It is further possible to combine the manipulating members in assemblies having more than two pairs of manipulating members, for example three, four or six pairs.

The elongate rod 35 has a circular cross-section, however, it may be configured to be D-shaped, at least slightly, to prevent it from rotating about the axis along which it moves.

Other configurations of the manipulation assembly arranged by the support head 30 may be possible, such as assemblies configured to constrain more than two manipulating members on either side of the assembly; or more than a total of four members, or two pairs of members.

In some embodiments, the first, second, third and fourth members may be arranged such that their respective distal ends form a rectangle configuration, which may include a square configuration. Other examples include trapezoidal, rhomboidal and parallelogram arrangements, depending on the specific treatment required by a user. In some examples the arrangement of the tips can advantageously be combined with the relative timing of driving different manipulating members, so as to manipulate vertebrae in a particular manner, for example rocking, twisting and/or dragging motions may be achieved with particular combinations of distal end arrangements and the timing of actuation of each manipulating member relative to one another. Such motions may beneficially massage the tissue to release tension.

Although it will be understood that in general, coupling manipulating members and driving them as a pair is advantageous, manipulating members may be driven individually and independently, for example each manipulating member may be driven by an actuator for that manipulating member. Manipulating the manipulating members individually can provide a personalised treatment profile.

The drive system can be adapted to drive manipulating members on the first side of the spine out of phase with manipulating members on the second side of the spine, or to drive the manipulating members on the first side of the spine and manipulating members on the second side of the spine in antiphase with one another. In other embodiments, the manipulating members may be driven in phase or both in anti-phase and in phase throughout a treatment profile, for varying durations, which may be more effective than driving the members consistently at the same phase. The drive system can drive the manipulating members with a constant cycle time or with a varying cycle time between the different members and can be configured to control assemblies individually and/or in combination with other assemblies, for example, according to a pre-determined program of the spinal therapy device.

FIGS. 3 and 4 illustrate an example embodiment of an array of manipulating assemblies arranged such that they are positioned along the length of a spine in a spinal therapy bed configuration.

A manipulating assembly 100 is mounted on a chassis 90. Manipulating assemblies are arranged on the chassis 90 in groups that correspond to different areas of the spine, namely the cervical, thoracic and lumbar vertebral regions.

The cervical region, at the top of the spine near the neck, is the smallest of the regions; the thoracic region is the middle and largest region; and the lumbar region is at the lower end of the spine adjacent the pelvis. Each of the regions has differing basic vertebral structures, such that the way in which they are to be manipulated varies from area to area. Manipulating assemblies adjacent one another form a group that corresponds to one of the regions of the spine.

The cervical region of the spinal therapy device comprises one manipulating assembly, each manipulating assembly comprising four manipulating members; the thoracic region comprises three manipulating assemblies and the lumbar region comprises two manipulating assemblies as shown in FIGS. 3 and 4.

The spacing of the groups is greater than the spacing of the manipulating members in the assembly. Preferably, the spacing between groups is 105 mm. The spacing of manipulating members in an assembly in a single group is less than this and is about 35 mm. The spacing between adjacent members in a group in a direction along the spine is maintained at a constant value such that the tip-to-tip distance between all of the manipulating members is approximately the same within a group and an assembly.

The assemblies that are arranged to treat the vertebrae in the cervical region have a spacing of manipulating members that is 65 mm, and the spacing of members in the thoracic and lumbar regions is 70 mm. The cervical vertebrae are smaller and thus closer together, which is reflected in the spacing. By mirroring the spacing of the assemblies with the spacing of the vertebrae in each region of the spine, a more accurate treatment can be given and a greater overall result of loosening the vertebral junctions may be achieved.

FIG. 5 illustrates the motion induced by the actuator, which is driven by the motor 65. The motor 65 drives the lead screw 55, which in turn provides movement to a Bowden cable bracket. The lead screw may be, for example, a T8×2 mm lead. In other examples, the reciprocating motion may be provided by other means, such as a rack and pinion gearing system. The bracket can move at 20 mm/s. The assembly is capable of moving 20 mm in either direction about a centre point and may be fitted with sensors that can prevent over driving the bracket. Bowden cables provide flexibility of force transfer amongst the apparatus, and require decoupled motion, which means that there is no chance for a direct drive from the motor to push the members straight into the back, which can be uncomfortable for a user if the force is too large. Bowden cables can also be joined between a pair of manipulating members on opposing sides of the spine such that they can move in synchronised anti-phase. If the Bowden cable's radius of curvature is too small, this can create unwanted friction. This can be improved by stepping the motor-to-member-cable connection, for example by driving the fourth member using the first motor.

FIG. 6 illustrates a Y-shaped module or bracket, which is one embodiment of the support head 30. The Y-shaped module advantageously provides a platform to support four manipulating members on one retraction pole or support shaft 85. This beneficially reduces the number of parts required for construction of the spinal therapy bed and simplifies the general architecture.

FIGS. 7, 8 and 9 illustrate the spinal therapy device in part of a massage bed assembly. The assembly comprises a bed structure 200, where the user or patient lies down face up on their back, and a footrest portion 220 that supports the lower body. The portion of the bed onto which the user lies is designed in a V-shape with an aperture 240 at the base of the V through which the spinal therapy device operates. The massage apparatus is arranged with a head support 210 that is integral to the bed (as shown in FIG. 9), although other configurations are also possible. Further support, for example to support the dorsal or lumbar back areas, may also be used (not shown).

The portion of the bed on which the user lies has an opening or aperture 240 that exposes the back to the manipulating members of the spinal therapy device. This portion of the bed is covered, as shown in FIGS. 8 and 10, such that there is an additional cushioning layer between the manipulating members and the spine, and the user is presented with a flat, bed-like surface on which to lie down. The angle of the aperture 240 with the bed 200, shown in FIG. 10, is designed for comfort and preferably has a value of about 20 degrees to cradle the user's back.

Dimensions of the bed 200 are preferably 500 mm high x 560 mm wide x 1265 mm long. These dimensions are suitable for transportation and manoeuvrability through doors and passageways. Other dimensions may be used to suit users who are particularly small (children for example) or particularly tall.

A leg raising portion 220 or cushion is provided, which extends out and may cradle the user's legs using extension mechanism 225. It may be set at a halfway point or fully extended depending on the preference of the user. In some cases, the leg raise may be used to position the user's spine in a particular way, and in this way can form part of the operation of the device in providing a treatment regime.

The leg raising portion 220 is longer on the top surface of the bed 200 than the bottom surface of the bed 200 to create a comfortable angle for the legs to rest. Preferably wherein parallelogram geometry is created by the top surface being longer than the bottom surface, where the angle at the top corner of the footrest is 8 degrees.

Reduction of the noise and vibration of the bed during treatment is prevented by spacers 230, which may preferably be made of rubber. The spacers 230 decouple the plate holding the motors from the rest of the chassis 90. In some cases, as shown in FIGS. 1 and 2, the actuators for driving the manipulating members are “floating” relative to the chassis 90. That is to say, they are not mounted on the chassis 90, so do not directly transfer vibrations to the chassis 90. In some cases, mechanical dampers can be included on the transmission path for mechanical vibrations. This can help to further reduce vibration transfer.

A treatment profile comprises a method to be executed by the spinal therapy bed 200. Individual manipulating members are addressed by the actuator, which causes them to move forwards and backwards in a linear motion. The linear motion produces a force into the user's back in the region of the spine that it engages. This force can be tailored, for example, by the surface area of the manipulating member or the speed with which it is driven. Sufficient force is provided to drive the manipulating member into the user's back with a massaging effect without causing damage.

Examples of treatment profiles and tailoring may include:

(1) Area of focus. The amount of time of a treatment profile spent, for example, focussing on a particular area of the spine, e.g. the neck. In some examples, a treatment could spend twice to three times longer on the neck than it does on upper back and/or lower back.

(2) Speed of the manipulating members: fast movements are felt by a user as being more ‘intense’ compared to slow movements which are perceived to be more ‘gentle’.

(3) Intensity: ranging from 0 to 10 that represents a fraction of how far each of the manipulating members move toward the corresponding treatment area from a neutral starting position and controls depth of massage into the spine.

(4) Treatment duration: ranging from around 5 minutes to about 40 minutes, depending on personal needs, time to spare, etc.

As an example, some specific treatment profiles may focus on the lower back, for example for treating sciatica or vertebral disc problems. Other programmes may be designed for treating headache, arm or shoulder pain caused by trapped nerve(s) around the neck and shoulder, by focussing on the neck and/or upper back region. In this context, “focus” may for example include the manipulating members in the region of focus: spending more time manipulating a particular spinal region; exerting more force while manipulating a particular spinal region; moving a larger distance while manipulating a particular spinal region; and/or moving faster while (relative to the regions which are not regions of focus).

Two manipulating members may be driven as a pair about a vertebra. The members can be manipulated individually to create a variety of massaging effects. The members can be driven in synchronous motion, for example, by being driven forwards and backwards at the same time to create a squeezing effect. They can also be driven in asynchronous motion such that one moves forwards as the other moves backwards. It will be appreciated that other motions between synchronicity and synchronicity can be performed. Typically, the cycle time of each manipulating member (time taken for a member to move forwards and backwards and return to the starting position) is constant such that the phase of the motion of the members is constant, though it does not have to be. Treatment profiles may comprise a mixture of massaging effects created by the manipulating members in a number of sequences.

Pairs of members are configured in assemblies such that two pairs address adjacent vertebrae. Members that are adjacent one another along the length of the spine are configured to be driven together. Members in assemblies are therefore typically driven to act as two pairs, so the massaging effect applied to a first pair is simultaneously applied to the second pair.

Assemblies can be driven with the same massaging effect along the length of the spine or with different effects. A rippling effect along the length of the spine can be developed by driving assemblies with the same cycle length and massaging effect at different starting points in the cycle. Other effects, such as a rocking motion, can be achieved by driving members on each side of the spine asynchronously. Twisting or zig-zag motions can also be created by assemblies in groups at the lumbar and cervical regions being driven in anti-phase with assemblies in the thoracic region. Different regions can experience different massaging effects where it is appropriate for individual users.

Machine learning techniques analyse data and automate analytical models. It is a branch of artificial intelligence based on the idea that systems can learn from data, identify patterns and make decisions with minimal human intervention. However, human intervention can be used to overrule machine learning decisions where appropriate. The machine learning can be performed across a large cross-section of users of the spinal therapy bed. Maintaining anonymity can be prioritised, and secure measures implemented to ensure patient confidentiality. However, metadata can be used to very quickly determine effective treatment profiles and learn efficient ways to treat users.

Parameters of the apparatus and method described above which can be altered in such learning techniques include: spacings and distances between manipulating members in assemblies and in different groupings (for example arranged according to a user's height), force with which to drive the manipulating members, tilt of the manipulating members controlling the angle of manipulation the spinous area of a patient, height of the footrest, treatment profiles including synchronisation of movement of manipulating members in different assemblies and/or on different sides of the spine, total length of treatment or lengths of particular stages or cycles within the treatment, distance of manipulating member to travel in one movement (which may change, or dynamically change, throughout a treatment), operating speed of a manipulating member (which may also change throughout a treatment); motions (e.g. ripple, twist, squeeze, rock) to be performed throughout the treatment and, optionally, instructions on how to achieve these motions using the plurality of manipulating members; duration and sequences of motions; force/pressure to be applied to the spine; and/or other parameters which can be controlled by a central unit or control system. Each of these parameters can be varied by the controller as part of an iterative learning experience. Further input such as measurements of force exerted (via current or voltage draw as set out below); measurement of actual extension as compared with the extension intended to be implemented by the controller; or even user satisfaction (or dissatisfaction) feedback can be used to allow the model to self-identify whether the changes were effective in improving the treatment profile for that particular user. When aggregated, this learning can be extremely useful in guiding the development of highly tailored treatment programs for new or existing users.

Machine learning and artificial intelligence can be used to improve the user experience and the effectiveness of the treatment. During a treatment, manipulating members move up and down along their axis by an amount determined by a control signal, for example the electrical current imparted by a motor coupled to each manipulating member (or group of members), and a different intensity felt by a user can be achieved based on the range of movement along the axis. This data can be used to model the behaviour of a treatment profile. An example of a model that can be used to determine a treatment profile is detailed below.

Training can be performed using the following steps. People with pains in different areas of the spine (upper, middle and lower back) are found and participate in a number of sessions until the best settings are found for their specific needs. Whether or not a particular motion has been appropriate can be determined (and fed back into the training model to verify the selection of motions, or suggest that a different motion be tried next time) by any suitable method. For example, users may self report satisfaction with the motion of the manipulating members (either continuously during treatment, or in general at the end of a session, over their whole spine, or in particular areas, etc. —the reporting can be as fine grained as desired). In other cases, the relationship between strength of control signal (e.g. current supplied to a motor) and the force exerted, the distance moved, the speed of motion, etc. can be used to infer whether the treatment provided by the manipulating members was appropriate for the particular tissue being manipulated, on a per-manipulating-member basis.

Indeed, the machine learning process can even learn from a user over multiple sessions. For example, tissue of a particular stiffness may become gradually relaxed over several sessions. In the training phase, the machine learning algorithm may be informed of the change in tissue stiffness (or other parameter(s)) over time as a user recovers from a particular condition. By inferring the relevant parameter(s) from the dynamics of the manipulating members as discussed above, the machine learning process can infer how far along the treatment is, and cause the manipulating members to make appropriate motions for that stage of the treatment. This process can also be used to feedback to the model, for further refinement, for example where a user is not responding as expected, alternative profiles may be implemented. The success or failure of these for improving the user's condition can be used to guide future treatments for other patients (the data are, of course suitably a.

Data is collected throughout the sessions concerning the electric currents and individual motor movements. Electrical current for N motors is denoted as X={X1, X2, . . . , XN} and the manipulating member position is denoted as Y={Y1, Y2, . . . , YN}, the AI model is a function Y =f(X). The function, f, is a recurrent neural network model that has the ability to observe the sequence of X over time such that it can make predictions and deliver the most appropriate treatment for a user.

The model is represented by a set of matrices W and hidden states h. At each time step, the model is given the input electrical current, X, and the output label, Y, then, using a neural network optimisation algorithm (e.g. ADAM, SGD, etc.), the matrices W are adapted to an optimal value.

Inference can be performed using the following steps. The system takes the electrical currents as input and predicts which part of the body is having a problem and from that, the system can deliver the most suitable treatment program for the user.

In some embodiments, additional parameters can be monitored, for example to learn when to stop driving the manipulating members into the spine. As the manipulating members push against the tissue, the current reading increases steadily for a short period of time before spiking when they manipulate and deform the tissue and press against the bony mass of the spine. This is illustrated by the sudden change in gradient in the graph of FIG. 11, which plots current against time for one cycle of the movement of the members. The motors driving the manipulating members require more current to push through more dense/higher tension tissue than soft/relaxed tissue. When plotted on an axis of current against time, the point at which the spike appears should decrease with time across the therapy session, indicating that the tissue is loosening. Monitoring the current feedback can be performed and utilised by machine learning techniques. Learning where the threshold or boundary between hard and soft tissue lies can be used in a number of scenarios.

The point just before a significant increase in gradient, as shown on the graph in FIG. 12 is indicative of a boundary between hard and soft tissue and can be learnt. By learning when in the cycle the change in gradient is going to happen, hitting bony mass can be avoided, which prevents injury or discomfort to the user. These measurements could be used to determine effectiveness of a treatment program and machine learning used to alter the program accordingly.

Machine learning can be used for personalising individual treatments or for creating more generic treatment profiles. Personalisation can be in one or more of the following areas:

1) Treatment area Given electrical current values for each motor, the model can predict the stiffness of the different areas of the back. It is believed that the harder the back, the more electrical current is needed to deliver a constant speed of movement of the manipulating members.

2) Treatment intensity and duration

Given the stiffness predicted, artificial intelligence and machine learning can predict from its training data that a particular stiffness level indicates a certain level of intensity should be used as has been trained from users who participated in training data.

For example, consider a sample of two users. A first user has a first stiffness of upper back of 8 out of 10 and during a massage, the first user often chooses a level of intensity of 5 out of 7. A second user has a similar stiffness of upper back, for example 7 out of 10, and the second user often chooses the level of intensity of 4 out of 7. This gives the AI training samples: 8:5, 7:4. A generalised model can be built on these results, including a number of additional results, that can be used to determine a treatment given any stiffness level, and any other factors such as users weight for example, and predict an appropriate intensity level for that user.

Treatment duration follows the same principle as the intensity learning.

A general library database can be created that stores group data such as applied control settings and measured thresholds, which can be used to inform future treatment profiles. For example, measuring where the hard-soft tissue boundary is likely to occur can be used to pre-set the positioning of physical parameters (e.g. the range of extent of manipulating members, their optimal angle of operation or geometric positioning within an assembly) and operating parameters (e.g. applied force, synchronicity of motion or session length). Group data may be used to, for example, generate informed treatment profiles for new users, which may provide a starting platform that can be personalised as treatment is undergone.

Treatment settings of individual patients may be stored and saved such that treatment sessions can both be planned according to individual needs and monitored to determine progression made over a series of treatment sessions. User specific details may be stored and accessed from a user library, which may be configured to automatically apply certain features before beginning a new treatment session (such as operating force/power or previously determined control variable thresholds),

Particular conditions may prove to show particular traits in back stiffness or respond in a predictable way to treatment sessions. Collecting and analysing data from each treatment session may be used to create a series of tailored, selectable treatment profiles, which are continuously modified and improved as more treatments are performed. For example, if it is determined that rippling motions are more successful at treating particularly stiff areas of the back compared to synchronous motions, treatment profiles may be suitably adapted to reflect this.

Remote diagnosis can also be performed from data collected during treatment, for example, from the current drawn by different components of the system. Such remote diagnosis may be used to select a pre-generated treatment profile from a library of selectable profiles. The library may contain profiles that have been created using machine learning techniques, ready-made profiles, or a mixture of both.

It will be appreciated from the above description that many features of the different examples are interchangeable with one another. The disclosure extends to further examples comprising features from different examples combined together in ways not specifically mentioned. Indeed, there are many features presented in the above examples and it will be apparent to the skilled person that these may be advantageously combined with one another.

1-91. (canceled)

92. A method of control for a spinal therapy bed, the spinal therapy bed comprising: a plurality of manipulation members spaced along the length of a user's spine and adjustable to the curvature of an individual user's spine and arranged to apply pressure from either side of the spine at multiple points along the spine, each manipulating member arranged to engage a user's spine at a respective vertebral area between a spinous process and a transverse process arranged to be driven from a proximal end and having a portion for engaging the spine at a distal end; and a drive system;
wherein the method comprises: controlling the drive system to actuate the manipulation members to apply pressure to their respective vertebral areas, wherein a plurality of the manipulation members are driven simultaneously and independently, wherein the spinal therapy bed further comprises sensors for monitoring the behavior of each manipulating member and wherein the method includes:
receiving measurements from the sensors, the measurements comprising at least a measurement indicative of a force applied by at least one manipulating member over a cycle in which the manipulating member moves towards and away from its respective vertebral area and returns to its starting position; and
adaptively adjusting the force applied by each manipulating member in response to the received measurements.

93. The method of claim 92 wherein a measurement indicative of a force applied is derived based on the current supplied to an actuator.

94. The method of claim 92 wherein the spinal therapy bed further comprises sensors for monitoring the distance travelled by each manipulating member and wherein the method includes:
receiving measurements from the sensors, the measurements comprising at least a measurement indicative of a distance travelled by at least one manipulating member over a cycle in which the manipulating member applies a time varying force to its respective vertebral area; and
adaptively adjusting the motion of each manipulating member in response to the received measurements.

95. The method of claim 92 wherein applying the pressure comprises changing a control variable:
receiving a profile of the control variable over the cycle;
identifying a threshold value of the control variable from the profile, wherein the threshold value is indicative of a time at which a statistically significant change in the control variable is determined; and
controlling the drive system based on the threshold value.

96. The method of claim 95 wherein the control variable is selected from current, power or voltage drawn by an actuator.

97. The method of claim 95 wherein the threshold value of the control variable is updated throughout a treatment regime.

98. The method of claim 95 wherein the threshold value of the control variable provides an indication of the relative firmness of the vertebral areas; and a treatment regime is adaptively developed based on the indication of relative firmness of the vertebral areas.

99. The method of claim 97, wherein the treatment regime includes: controlling or changing distances for each manipulating member to extend during treatment; controlling or changing forces for each manipulating member to exert during treatment; and/or controlling or changing relative start points for each manipulating member.

100. The method of claim 92, wherein the independent driving includes:
rippling motion with a constant phase between adjacent manipulating members;
adjacent manipulating members being driven in antiphase;
and/or different motions in cervical, thoracic and lumbar portions of a user's spine.

101. The method of claim 92, wherein the spinal therapy bed includes an adjustable leg support and the method includes adjusting the height of the adjustable leg support at specific timings during a treatment process.

102. The method of claim 92 wherein the drive system is fitted with a cut out operable to stop the driving system from driving one or more manipulating members if an actuator draws more than a threshold value of current, voltage or power.

103. A spinal therapy apparatus arranged to deliver a spinal therapy comprising:
a plurality of manipulation members spaced along the length of a user's spine and adjustable to the curvature of an individual user's spine and arranged to apply pressure from either side of the spine at multiple points along the spine, each manipulating member arranged to engage a user's spine at a respective vertebral area between a spinous process and a transverse process arranged to be driven from a proximal end and having a portion for engaging the spine at a distal end;
a drive system;
a controller for controlling the drive system to actuate the manipulation members to apply pressure to their respective vertebral areas, wherein a plurality of the manipulation members are driven simultaneously and independently,
a force sensing arrangement for determining at least a measurement indicative of a force applied by at least one manipulating member over a cycle in which the manipulating member moves towards and away from its respective vertebral area and returns to its starting position; and
wherein the controller in configured to adaptively adjust the force applied by each manipulating member in response to the received measurements.

104. A spinal therapy apparatus according to claim 103 including control logic arranged to perform a method according to claim 92.

105. A method of control for a spinal therapy device of claim 103, the method comprising:
determining control signals for controlling a plurality of manipulating members of the spinal therapy device based on a stored treatment profile, wherein the plurality of manipulating members are arranged to engage a user's spine at a respective vertebral area between a spinous process and a transverse process; applying the control signals to drive the manipulating members in at least one cycle to implement a treatment regime;
receiving feedback signals from a plurality of sensors indicative of at least one of pressure and movement applied on the user's spine by the plurality of manipulating members during the at least one cycle; and
determining adjusted control signals based on the control signals of the stored treatment profile and the received feedback signals to implement an updated treatment regime.

106. The method of claim 105 wherein the adjusted control signals are determined using machine learning algorithms.

107. The method of claim 105 further comprising applying the adjusted control signals in a subsequent cycle, optionally further comprising updating the treatment regime based on the adjusted control signals.

108. The method of claim 105 further comprising storing a new treatment profile based on the updated treatment regime.

109. The method of claim 105 wherein the stored treatment profile is selected from a library of treatment profiles, optionally stored at a central server, optionally wherein the library comprises treatment profiles selectable from one or more of the following:
a general treatment profile; and/or
a personal treatment profile developed for a user based at least in part on feedback signals from the user.

110. The method of claim 105, the method further comprising generating a general treatment profile for a spinal therapy device, the method further comprising:
receiving at a first plurality of spinal therapy devices, a first treatment profile from a library comprising a plurality of treatment profiles;
performing, the method of controlling the spinal therapy device of any one of claims 14-18 using the first treatment profile as the stored treatment profile;
receiving by a central unit, feedback signals from the plurality of spinal therapy devices;
processing by the central unit, the feedback signals to determine a general treatment profile to be used in a subsequent treatment; and
storing the general treatment profile in the library.

111. The method of claim 110 further comprising; generating a plurality of general treatment profiles based on performing the method of claim 110 on multiple treatment profiles in the library.
